(19) United States
(12) Patent Application Publication
(10) Pub. No.: US 2016/0359215 A1
(43) Pub. Date: Dec. 8, 2016

(54) Dielectric Waveguide Filter And Dielectric Waveguide Duplexer

(71) Applicant: TOKO, INC., Tsurugashima-shi (JP)

(72) Inventor: Yukikazu YATABE, Tsurugashima-shi (JP)

(73) Assignee: TOKO, INC., Tsurugashima-shi (JP)

(21) Appl. No.: 15/168,938

(22) Filed: May 31, 2016

(30) Foreign Application Priority Data
Jun. 2, 2015 (JP) 2015-111976

(51) Int. Cl. H01P 1/213; H01P 1/201; H01P 1/20; H01P 7/10

(52) U.S. Cl. CPC H01P 1/2002; H01P 7/10; H01P 1/201

(57) ABSTRACT

Dielectric waveguide comprising a plurality of resonator groups disposed on a substrate, wherein each of the resonator groups comprises one or more integrally-formed resonators, each obtained by coating a dielectric body with a conductor film, wherein each resonator group in at least a set of resonator groups of the plurality of resonator groups comprises waveguide-side slot exposing the dielectric body in a bottom surface thereof, wherein the substrate comprises a cavity surrounded by conductor patterns formed in the upper and lower surfaces, and by a via hole connecting the conductor patterns in the upper and lower surfaces, wherein the cavity comprises a set of substrate-side slots exposing the core material, the set of substrate-side slots being provided at a position to which waveguide-side slots of the set of resonator groups are opposed, and wherein resonator groups in the set of resonator groups are coupled together via the cavity.

### CROSS-REFERENCE TO RELATED APPLICATION

Basic application: Japanese Patent Application No. 2015-111976 filed on Jun. 2, 2015.

### BACKGROUND OF THE INVENTION

1. Field of the Invention

The present invention relates to a dielectric waveguide filter and a dielectric waveguide duplexer, obtained by connecting a plurality of dielectric waveguide resonators with each other.

2. Description of the Related Art

There has been used a dielectric waveguide filter formed by coupling a plurality of TE mode dielectric waveguide resonators to acquire a desired frequency characteristic. In a dielectric waveguide filter for use in a high-frequency band of tens of GHz or more, a crystal having lower permittivity is used as a dielectric material for the dielectric waveguide resonator so as to prevent a dimension of the resonator from becoming too small.

### BRIEF SUMMARY OF THE INVENTION

### Problem to be solved by the Invention

JP 10-290104A describes a dielectric waveguide filter comprising TE mode dielectric waveguide resonators, each comprising a rectangular parallelepiped-shaped dielectric block having an outer periphery coated with a conductor film, wherein each of the dielectric waveguide resonators is provided with a coupling window in a side surface thereof, the coupling window exposing a dielectric body, and the dielectric waveguide resonators are coupled to each other via the opposed coupling windows.

The dielectric waveguide filter having this type of structure is likely to cause, at the time of arranging the dielectric waveguide resonators, an error in the position or dimension of the coupling window due to positional displacement of the dielectric waveguide resonators, or leakage of electromagnetic field from the coupling window due to a gap generated between the dielectric waveguide resonators, leading to significant degradation of frequency characteristic. To achieve the frequency characteristic as designed, it is required to have a positional accuracy of a few pm or less, and thus, such a structure has the drawback of requiring a high level of difficulty at the time of assembly, and being difficult to be mass produced.

JP 2002-043807A describes a dielectric waveguide filter comprising a plurality of TE mode dielectric waveguide resonators, wherein the dielectric waveguide resonators are formed by providing constricted portions at a predetermined interval in a rod-like dielectric block having a rectangular cross-section, and coating a surface of the dielectric block with a conductor film. The dielectric waveguide filter having this type of structure only requires a low level of difficulty at the time of assembly and is easy to be mass produced because the plurality of resonators can be integrally formed and it is not necessary to align the individual dielectric waveguide resonators with each other.

However, such a structure has the drawback of being difficult to be applied to a dielectric waveguide filter in which connection between dielectric waveguide resonators is complicated.

### Means for Solving the Problem

A dielectric waveguide filter of the present invention comprises: a substrate comprising a core material having upper and lower surfaces, each formed with a conductor pattern; and a plurality of resonator groups disposed on the substrate, wherein each of the resonator groups comprises one or more integrally-formed resonators, each obtained by coating a dielectric body with a conductor film, wherein each resonator group in at least a set of resonator groups of the plurality of resonator groups comprises waveguide-side slot exposing the dielectric body in a bottom surface thereof, wherein the substrate comprises a cavity surrounded by conductor patterns formed in the upper and lower surfaces, and by a via hole connecting the conductor patterns in the upper and lower surfaces, wherein the cavity comprises a set of substrate-side slots exposing the core material, the set of substrate-side slots being provided at a position to which waveguide-side slots of the set of resonator groups are opposed, and wherein resonator groups in the set of resonator groups are coupled together via the cavity.

### Effect of the Invention

The present invention makes it possible, even in the case of a dielectric waveguide filter in which connection between dielectric waveguide resonators is complicated, to provide a dielectric waveguide filter with less degradation of frequency characteristic due to a positional displacement at the time of assembly, which only requires a low level of assembly difficulty and is easy to be mass produced.

### BRIEF DESCRIPTION OF THE DRAWINGS

FIG. 1 is an exploded perspective view illustrating one embodiment of a dielectric waveguide filter of the present invention.

FIG. 2 is a graph illustrating a simulation result of a frequency characteristic in one embodiment of the dielectric waveguide filter of the present invention.

FIG. 3 is a graph illustrating a simulation result of a frequency characteristic in one embodiment of the dielectric waveguide filter of the present invention.

FIG. 4 is an exploded perspective view illustrating another embodiment of the dielectric waveguide filter of the present invention.

### DETAILED DESCRIPTION OF THE INVENTION

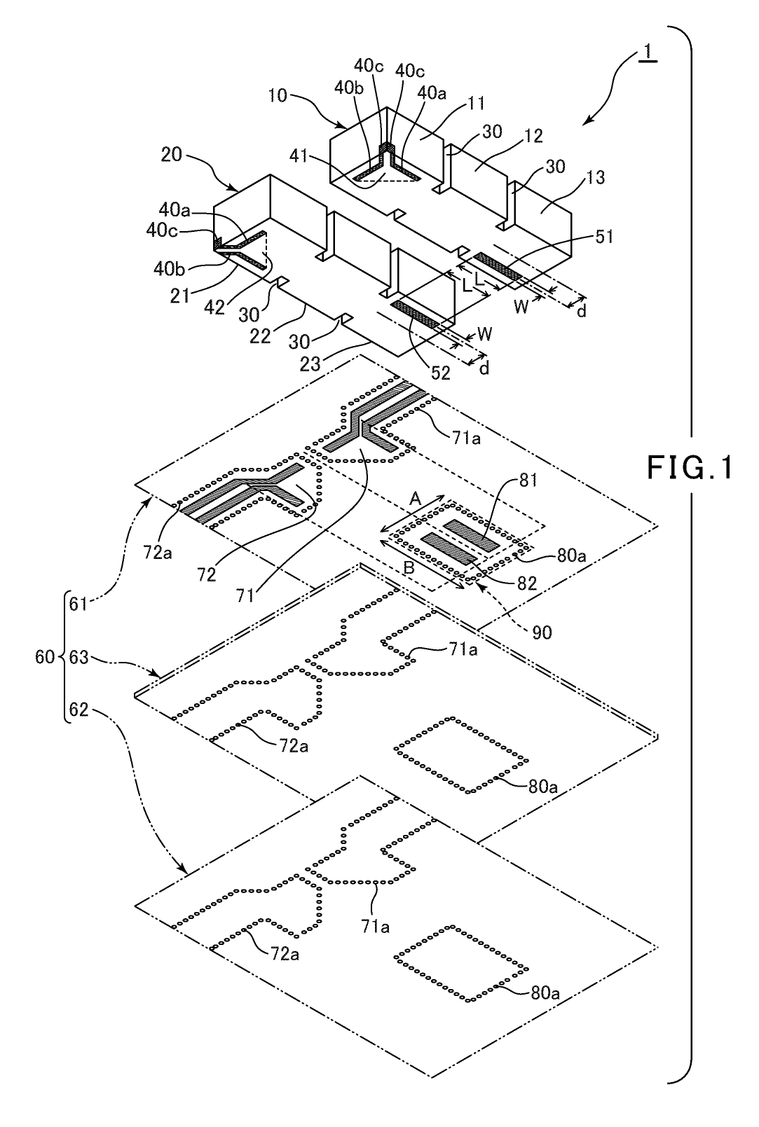

FIG. 1 illustrates an exploded perspective view for explaining one embodiment of a dielectric waveguide filter of the present invention. As illustrated in FIG. 1, a dielectric waveguide filter 1 comprises a substrate 60 composed of a core material 63, a front surface-side pattern 61 and a back surface-side pattern 62, and resonator groups 10, 20 disposed on the substrate 60. In FIG. 1, an exposed dielectric portion is cross hatched, and an exposed core material portion is slashed.

The resonator groups 10, 20 are formed by providing a plurality of constricted portions 30 at a predetermined interval on opposite sides of a rectangular parallelepiped-shaped dielectric block, and coating a surface of the dielectric block with a conductor film. The resonator groups 10, 20 comprise TE mode resonators 11, 12, 13 and TE mode resonators 21, 22, 23, respectively.

The resonator groups 10, 20 are disposed to allow the resonators 11, 12, 13 and the resonators 21, 22, 23 to be adjacent to each other, such that the dielectric waveguide filter 1 comprises a resonator of six elements arranged in two rows and three columns.

Each of the resonators 11, 21 has a bottom surface provided with respective one of input/output electrodes 41, 42. Each of the input/output electrodes 41, 42 extends in a linear fashion from a corner toward a center of the bottom surface, and radially expands in width along the way. A dielectric body is exposed on both sides 40a, 40b of the input/output electrodes 41, 42 and on a periphery 40c of the input/output electrodes 41, 42 on the side surface of the resonator groups 10, 20, and a distal end of each of the input/output electrodes 41, 42 is connected to the conductor film.

Each of the resonators 13, 23 has a bottom surface provided with respective one of waveguide-side slots 51, 52 exposing a dielectric body. The waveguide-side slots 51, 52 have a length L and a width W, and are disposed parallel to each other in their longitudinal direction with respect to a surface to which resonator groups 10 and 20 adjoin so as to facilitate coupling between the resonators 13 and 23. Further, the waveguide-side slots 51, 52 are disposed offset by a distance d from a center of each of the resonator groups 10, 20 in a direction of the surface to which resonator groups 10 and 20 adjoin.

The patterns in each of bottom surfaces of the resonator groups 10 and 20 are symmetric with each other with respect to a surface to which resonator groups 10 and 20 adjoin.

The back surface-side pattern 62 is a full solid pattern.

The front surface-side pattern 61 includes input/output lines 71, 72 provided at a position opposed to input/output electrodes 41, 42, and substrate-side slots 81, 82 provided at a position opposed to waveguide-side slots 51, 52. The front surface-side pattern 61 is a solid pattern, except for opposite sides of the input/output lines 71, 72, and the substrate-side slots 81, 82.

Each of the input/output lines 71, 72 and the substrate-side slots 81, 82 have substantially the same shape as respective ones of outer shapes of the input/output electrodes 41, 42 and the waveguide-side slots 51, 52, but are formed slightly larger in their outer shapes.

The input/output lines 71, 72 are connected by microstrip lines to an external device which is not illustrated.

Each of the input/output lines 71, 72 are surrounded by respective one of via holes 71a, 72a connecting the front surface-side pattern 61 to the back surface-side pattern 62, and the substrate-side slots 81, 82 are surrounded by a via hole 80a connecting the front surface-side pattern 61 to the back surface-side pattern 62.

Hereinafter, a region (A×B) surrounded by the front surface-side pattern 61, the back surface-side pattern 62 and the via hole 80a is referred to as a cavity 90. The cavity 90 does not operate as a resonator, but operates in a similar fashion to a coupling window of a conventional dielectric waveguide filter.

In the case of conventional dielectric waveguide filter formed by coupling the resonators using a coupling window, the size of the coupling window is limited by the size of a side surface of the dielectric waveguide resonator. However, in the dielectric waveguide filter of the present invention, the size of the cavity can be increased as far as the substrate permits.

In the dielectric waveguide filter 1 described above, coupling strength between the resonator 13 and the resonator 23 is determined by the size L×W of the waveguide-side slots 51, 52 and the distance of offset d, wherein the coupling strength is increased as the size L×W becomes larger and the distance d becomes longer.

Further, the size A×B of the cavity 90 determines whether the coupling between the resonators 13 and 23 is a capacitive coupling or an inductive coupling, wherein a larger size A×B results in the capacitive coupling and a smaller size A×B results in the inductive coupling.

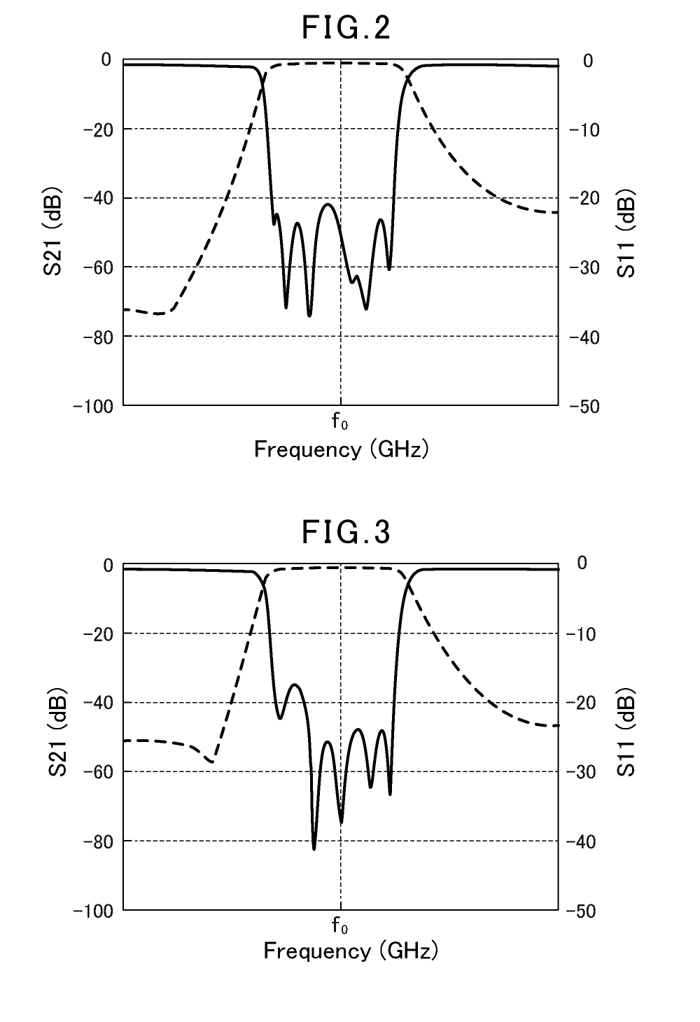

FIGS. 2 and 3 are graphs illustrating a result of simulating a frequency characteristic of the dielectric waveguide filter 1 of the present invention, where FIG. 2 illustrates a frequency characteristic in the case of arranging the resonator groups 10 and 20 without any error, and FIG. 3 illustrates a frequency characteristic in the case of arranging the resonator groups 10 and 20 with a gap of 0.1 mm provided therebetween.

In FIGS. 2 and 3, the horizontal axis represents a frequency, the vertical axis represents dB, the solid line represents a return loss (S11), and the dashed line represents an insertion loss (S21).

It can be seen from FIGS. 2 and 3 that even with a great gap provided between the resonator groups 10 and 20, the resultant change in the frequency characteristic is small.

In the case of conventional dielectric waveguide filter comprising resonators coupled to each other using a coupling window, the gap between the resonators causes electromagnetic field to be leaked from the gap, resulting in a significant degradation of frequency characteristic. On the other hand, even if there is a gap between the resonator groups, the dielectric waveguide filter of the present invention does not allow any leakage of electromagnetic field from the gap, and even if the positions of waveguide-side slots are displaced in some degree with respect to the cavity, there is less change in the coupling strength. This makes it possible to provide a dielectric waveguide filter with little degradation in frequency characteristic due to the positional displacement.

In the above embodiment, the outer shape of the substrate-side slots is preliminarily made larger than that of the waveguide-side slots so that the positions of waveguide-side slots are allowed to be displaced with respect to the cavity.

While the dielectric waveguide filter in the above embodiment is formed by using two resonator groups of one row and three columns, and one cavity, various combinations are possible.

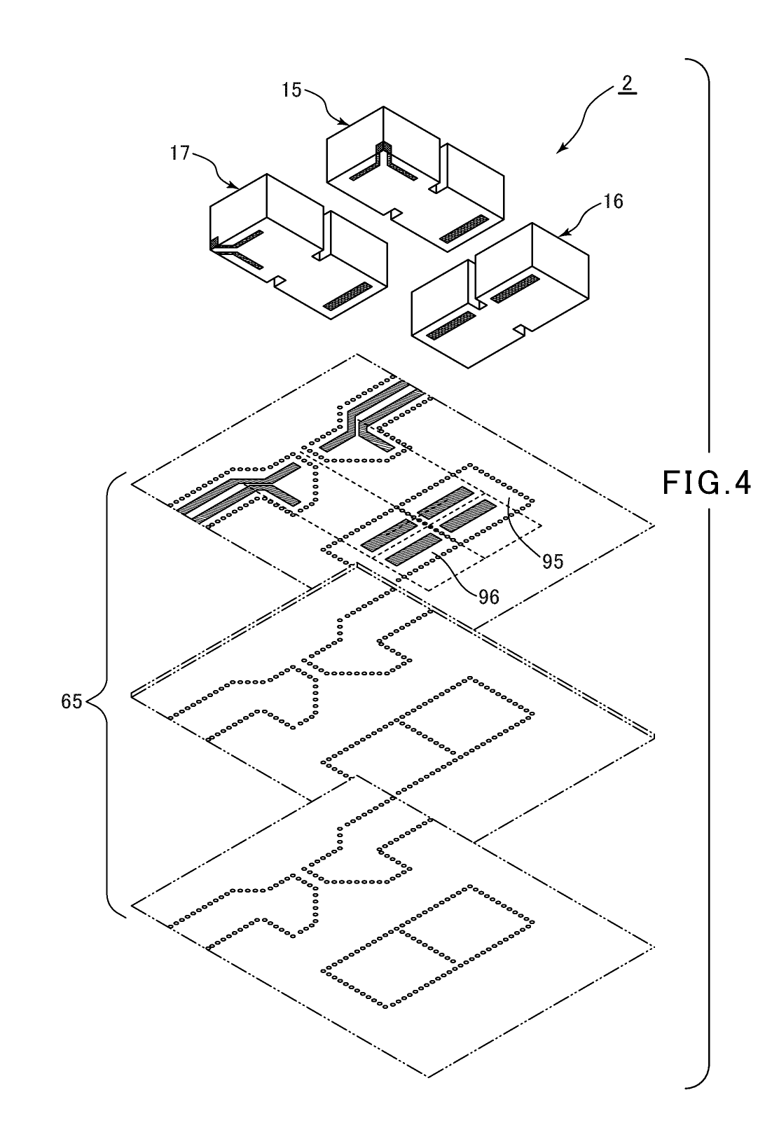

FIG. 4 is an exploded perspective view illustrating another embodiment of the dielectric waveguide filter. A dielectric waveguide filter 2 comprises resonator groups 15, 16, 17, each composed of a resonator of two elements, wherein coupling is made between the resonator groups 15 and 16, and between the resonator groups 16 and 17 using respective one of cavities 95, 96 provided in a substrate 65.

In this way, resonator groups comprising integrally-formed resonators having a simple structure can be coupled via cavities which do not cause any degradation of frequency characteristic even in the presence of a gap between the resonator groups, to thereby make it possible to easily produce a dielectric waveguide filter with complicated resonator combination. This structure is useful, for example, in the case of using a crystal as a dielectric material because it is difficult to process the crystal into a complicated shape.

The dielectric waveguide filter groups to be combined, or the resonator groups to be coupled using the cavity can be appropriately selected according to ease of combination, and the convenience of sizes of the dielectric material and the cavity.

While the above embodiment has been described for the case of being applied to a dielectric waveguide filter, it may also be applicable to a dielectric waveguide duplexer.

### EXPLANATION OF CODES

1, 2: dielectric waveguide filter
10, 20, 15, 16, 17: resonator group
11, 12, 13, 21, 22, 23: resonator
30: constricted portion
41, 42: input/output electrode
51, 52: waveguide-side slot
60, 65: substrate
61: front surface-side pattern
62: back surface-side pattern
63: core material
71, 72: input/output line
81, 82: substrate-side slot
71a, 72a, 80a: via hole
90, 95, 96: cavity

1. A dielectric waveguide filter, comprising:
a substrate comprising a core material having upper and lower surfaces, each formed with a conductor pattern; and
a plurality of resonator groups disposed on the substrate, wherein each of the resonator groups comprises one or more integrally-formed resonators, each obtained by coating a dielectric body with a conductor film,
wherein each resonator group in at least a set of resonator groups of the plurality of resonator groups comprises waveguide-side slot exposing the dielectric body in a bottom surface thereof,
wherein the substrate comprises a cavity surrounded by conductor patterns formed in the upper and lower surfaces, and by a via hole connecting the conductor patterns in the upper and lower surfaces,
wherein the cavity comprises a set of substrate-side slots exposing the core material, the set of substrate-side slots being provided at a position to which waveguide-side slots of the set of resonator groups are opposed, and
wherein resonator groups in the set of resonator groups are coupled together via the cavity.

2. The dielectric waveguide filter as defined in claim 1, wherein substrate-side slots in the set of substrate-side slots are parallel to each other.

3. The dielectric waveguide filter as defined in claim 2, wherein each of the substrate-side slots has an outer shape that is larger than an outer shape of each of the opposed waveguide-side slots.

4. A dielectric waveguide duplexer employing the dielectric waveguide filter as defined in claim 1.
